(19) United States
(12) Patent Application Publication
(10) Pub. No.: US 2006/0115282 A1
(43) Pub. Date: Jun. 1, 2006

(54) Image forming apparatus and touch panel display method of the same

(75) Inventor: Toshimi Yamashita, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/280,297

(22) Filed: Nov. 17, 2005

(30) Foreign Application Priority Data
Nov. 30, 2004 (JP) 2004-346855

(51) Int. Cl. G03G 15/00

(52) U.S. Cl. 399/23; 399/81

(57) ABSTRACT

When there are sheets of paper in paper cassettes of a main body of an apparatus, symbols of a paper size display of an image forming apparatus graphic displayed on a touch panel are lit and indicated at clear density. On the other hand, when the paper cassettes are empty, the symbols of the paper size display blink or the density of the symbols is made lower or is turned off, thus a warning is displayed. By doing this, a user, only by looking at the image forming apparatus graphic, can easily recognize which paper cassette is empty.

### CROSS-REFERENCE TO RELATED APPLICATION

This application is based upon and claims the benefit of priority from the prior Japanese Application No. 2004-346855, filed on Nov. 30, 2004, the entire contents of all of which are incorporated herein by reference.

### FIELD OF THE INVENTION

The present invention relates to an image forming apparatus having a touch panel for selecting any of a plurality of paper cassettes and a touch panel display method of the image forming apparatus.

### DESCRIPTION OF THE BACKGROUND

An image forming apparatus such as a copier or a printer generally has a plurality of paper cassettes for respectively storing various sheets of paper. When forming an image, selection of a paper cassette according to the paper kind for forming the image is set by a display panel. As a display panel for setting selection of a desired paper cassette, an art for displaying existence of mounting of a paper cassette and existence of sheets of paper in the paper cassette in a one-to-one correspondence with the paper size is disclosed in Japanese Patent Publication No. 3-263391.

The image forming apparatus disclosed in Japanese Patent Publication No. 3-263391 displays both paper sizes of two removable paper cassettes, displays separately the selected paper cassette and non-selected paper cassette, and also displays a no-paper mark.

The indication of the display panel of the image forming apparatus disclosed in Japanese Patent Publication No. 3-263391 is for selection of a paper cassette by the selection key. On the other hand, in recent years, as an input apparatus for setting the selection of a paper cassette, a touch panel capable of performing an input operation of information from the display panel has been developed.

However, although the conventional touch panel discriminates and displays the paper size and material in a paper cassette using symbols, existence of sheets of paper of the desired size in the paper cassette cannot be discriminated from the indication of the symbol. Therefore, a user, when touching the symbol part of the screen on the touch panel, looks at the indication of no existence of sheets of paper in another display area, recognizes no sheets of paper stored in the paper cassette, thus a problem arises that the operability at time of selection of the paper cassette is impaired.

### SUMMARY OF THE INVENTION

The present invention was developed to solve the problem aforementioned and is intended to provide an image forming apparatus and a touch panel display method of the image forming apparatus for easily recognizing the paper kind in a paper cassette and existence of sheets of paper in the paper cassette by looking at a screen displayed on a touch panel and eliminating an unnecessary touch operation by a user.

According to the embodiments of the present invention, there is provided an image forming apparatus comprising: a main body; a plurality of paper cassettes provided in the main body to respectively store sheets of paper; a touch panel equipped with a selection screen to indicate graphics to express the plurality of paper cassettes and by touching one of the indicated graphics by a user, selecting one paper cassette to be used; and a display controller, among graphics to indicate the plurality of paper cassettes, to control so as to change an indication condition between a case that sheets of paper are stored in the paper cassettes and a case that no sheets of paper are stored therein.

Furthermore, according to the embodiments of the present invention, there is provided a touch panel display method of an image forming apparatus to display the cassette selection screen to select any of a plurality of paper cassettes provided in a main body of the apparatus on a touch panel for which a user can perform a touch operation, comprising: detecting whether sheets of paper are stored in the plurality of paper cassettes or not; and changing an indication of the cassette selection screen according to detecting results of whether the sheets of paper are stored or not.

### BRIEF DESCRIPTION OF THE DRAWINGS

FIG. 1 is a front view showing the outside appearance of the image forming apparatus equipped with the touch panel of the first embodiment of the present invention;

FIG. 2 is a plan view showing the condition of the waiting screen displayed on the touch panel of the first embodiment of the present invention;

FIG. 3 is a plan view showing the condition of the paper size selection screen displayed on the touch panel of the first embodiment of the present invention:

FIG. 4 is a schematic circuit diagram for displaying on the touch panel on the basis of detection results from the paper detector:

FIG. 5 is a flow chart showing the operation of the first embodiment of the present invention;

FIG. 6 is a plan view showing the condition of the waiting screen displayed on the touch panel of the second embodiment of the present invention; and

FIG. 7 is a plan view showing the condition of the paper size selection screen displayed on the touch panel of the second embodiment of the present invention.

### DETAILED DESCRIPTION OF THE INVENTION

The present invention changes the indication of the paper cassette selection screen for selecting a paper cassette from the touch panel between a case that there are sheets of paper in the paper cassette and a case that there are no sheets of paper, thus a user can surely recognize the condition of the paper cassette.

### First Embodiment

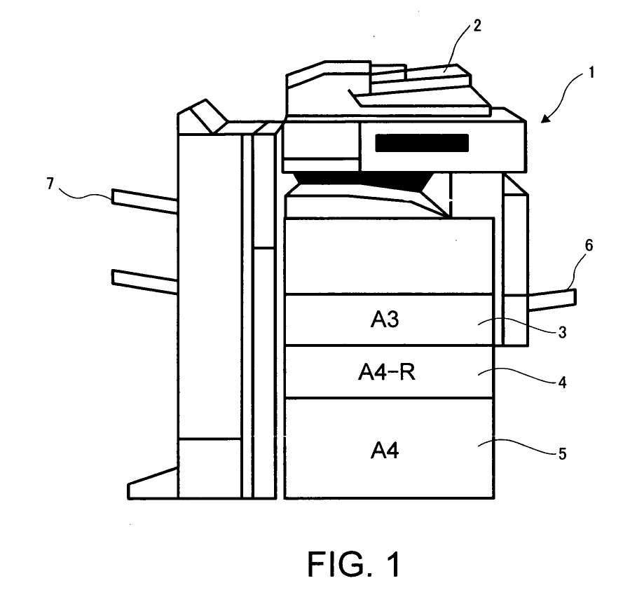

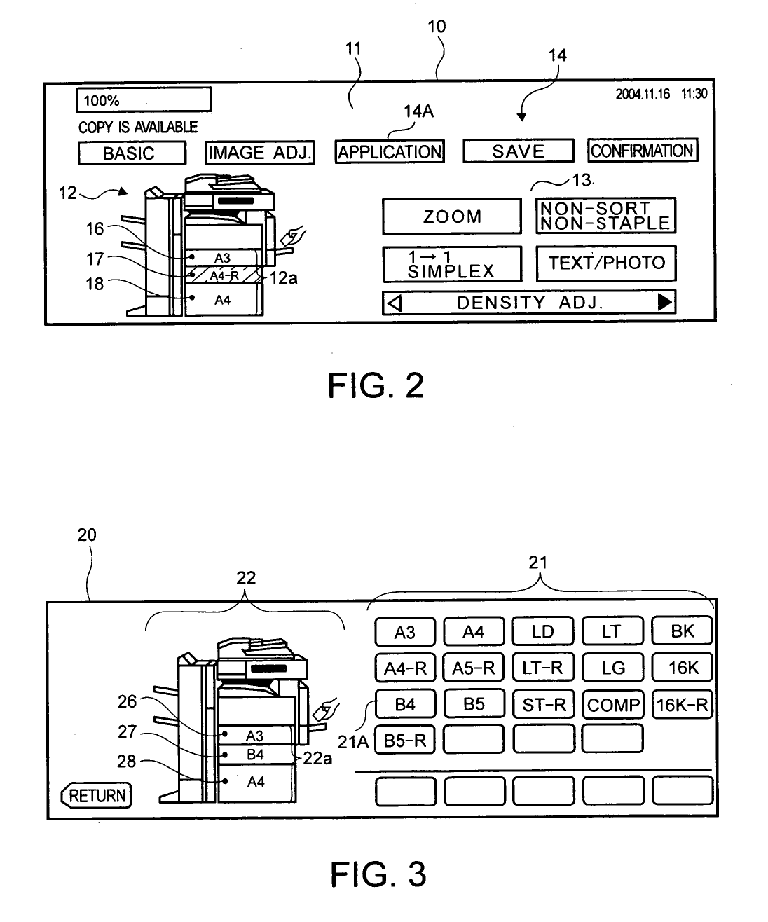

Hereinafter, the first embodiment of the present invention will be explained with reference to FIGS. 1 and 2. FIG. 1 shows the outside appearance of the image forming apparatus of the present invention. On the upper part of main body 1, automatic document feeder 2 for automatically conveying documents to be copied onto a platen glass is installed. In main body 1, as is generally known, a photosensitive drum, a charger, an exposure, a developing apparatus, a transfer device, and a fixing device composing the image forming unit are arranged. Furthermore, a plurality of paper cassettes 3, 4, and 5 for storing sheets of paper to which a developer image formed on the photosensitive drum is transferred and displaying the size of sheets of paper stored are arranged on the lower part of main body 1. For example, in paper cassette 3, sheets of paper of size A3 are stored, and in paper cassette 4, sheets of paper of size A4-R are stored, and in paper cassette 5, sheets of paper of size A4 are stored.

On the right side of main body 1, manual paper supply portion 6 for inserting sheets of paper by hand is installed. Furthermore, on the left side of main body 1, a paper receiving tray for receiving sheets of paper imaged and discharged is attached.

FIG. 2 shows touch panel 10 on the operation panel installed on the top of main body 1 of the image forming apparatus shown in FIG. 1. Main body 1 of the image forming apparatus, as described above, has three stages of paper cassettes 3, 4, and 5 for storing various kinds of sheets of paper, for example, different in size or material. Touch panel 10, at time of the image forming operation or at time of the maintenance operation, displays input information necessary for a user to operate and inputs operation information by touching the displayed icon.

The operation screen of touch panel 10 shown in FIG. 2 is waiting screen 11 showing the condition of waiting of main body 1. On waiting screen 11, image forming apparatus graphic 12 equivalent to main body 1, various condition setting icons 13 necessary at time of image forming and mode switching icon 14 are displayed. For example, as shown in FIG. 1, when sheets of paper of sizes A3, A4-R, and A4 are respectively stored in paper cassettes 3, 4, and 5 at the upper stage, medium stage, and lower stage of main body 1, in the areas of paper cassette graphics 16, 17, and 18 at the upper stage, medium stage, and lower stage of paper size display 12a of image forming apparatus graphic 12, the paper sizes are displayed by the symbols of A3, A4-R, and A4.

The symbols displayed in paper cassette graphics 16, 17, and 18 at the upper stage, medium stage, and lower stage are set by a user in accordance with the kind of sheets of paper actually stored in paper cassettes 3, 4, and 5 of main body 1. For example, when the sheets of paper in paper cassette 3 at the upper stage of main body 1 are changed from size A3 to size B4, the user firstly touches application icon 14a of mode changing icon 14. By doing this, on touch panel 10, paper size selection screen 20 of each cassette shown in FIG. 3 is displayed. Next, the user touches and selects paper cassette graphic 26 at the upper stage of paper size display 22a of image forming apparatus graphic 22 on paper size selection screen 20 and then touches B4 icon 21a of paper size selecting portion 21. By doing this, the symbol displayed on paper cassette graphic 26 at the upper stage of image forming apparatus graphic 22 is changed from A3 to B4. Changed image forming apparatus graphic 22 on paper size selection screen 20 is also applied to image forming apparatus graphic 12 on waiting screen 11.

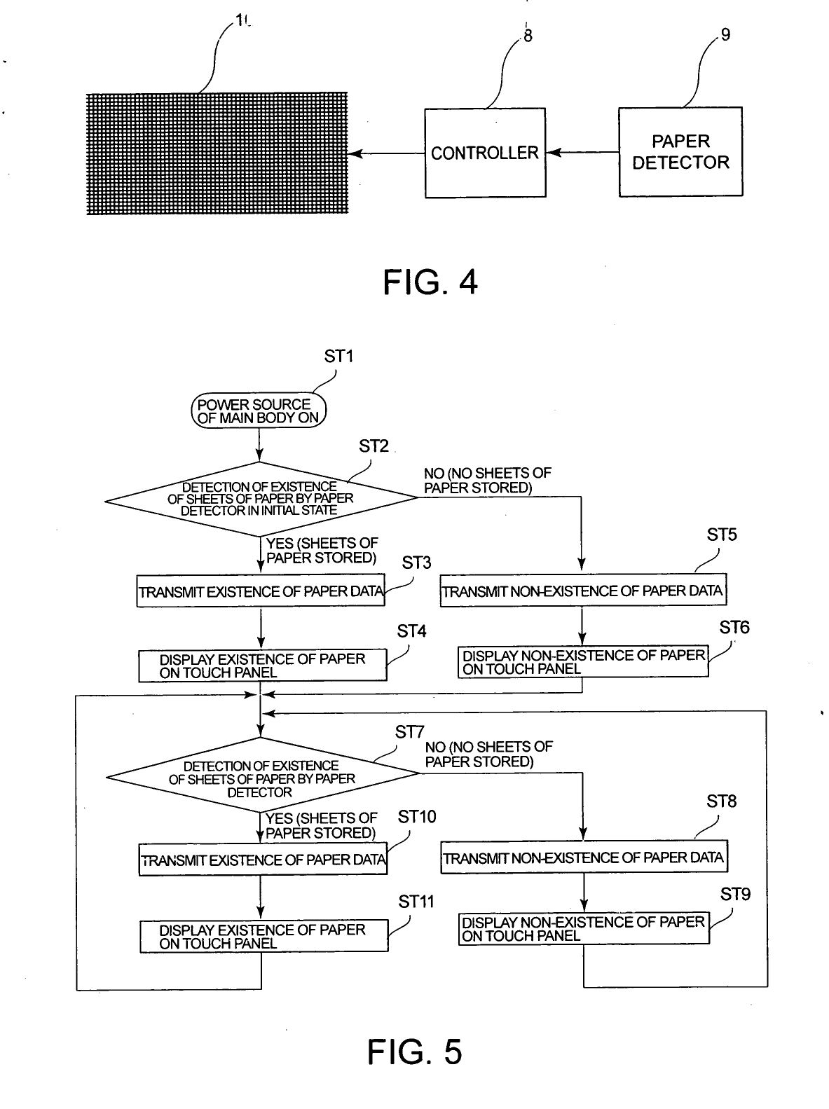

In main body 1, when the sheets of paper in each paper cassette are all used up, paper detector 9 shown in FIG. 4 detects that there are no sheets of paper. When paper detector 9 detects that there are no sheets of paper, controller 8 installed in main body 1 changes the indication of the stage equivalent to the empty paper cassette of paper size display 12a of image forming apparatus graphic 12 of touch panel 10. Namely, when there are sheets of paper in the paper cassettes of main body 1, the symbols displayed on paper size display 12a are lit and indicated at clear density. In this state, for example, when the sheets of paper in the paper cassette 4 at the medium stage of main body 1 are used up, the conditions are changed so that symbol A4-R of paper cassette graphic 17 at the medium stage of paper size display 12a blinks or the density of the symbol is made lower or is turned off, thus a warning is given to the user that paper cassette 4 at the medium stage is empty.

As shown in FIG. 4, touch panel 10 is structured by arrangement of dots composed of many liquid crystal elements. Touch panel 10 is connected to paper detector 9 via controller 8. Paper detector 9 uses a mechanical detection method using an actuator or an optical detection method using an optical sensor. As mentioned above, the changing such that symbol A4-R of paper cassette graphic 17 at the medium stage blinks or the density of the symbol is made lower or is turned off is executed as indicated below.

Namely, “blinking” is executed by transmitting an ON/OFF signal to the dots composing the paper cassette graphic of touch panel 10 from controller 8.

“Making the density lower” is executed by transmitting the density data to be displayed to the dots composing the paper cassette graphic to be displayed from controller 8. In this case, unless the aforementioned liquid crystal elements are color liquid crystals, the density cannot be changed.

“Turning the symbol off” is executed by transmitting an OFF signal to the dots composing the paper cassette graphic to be displayed from controller 8.

A user intending to use sheets of paper of size A4-R, from the condition that symbol A4-R of paper cassette graphic 17 at the medium stage blinks or the density of the symbol is made lower or is turned off, can recognize that the paper cassette is empty only by looking at touch panel 10. The user recognized can replenish sheets of paper to paper cassette 4. When sheets of paper are replenished to paper cassette 4 and the sheets of paper are detected by paper detector 9, the warning indication of paper cassette graphic 17 at the medium stage of paper size display 12a is cancelled and symbol A4-R is returned to the lighting indication at clear density.

Further, when an optional paper cassette becomes empty and any other paper cassette is a cassette of the same paper size, it is possible to instruct an auto cassette change operation by controller 8, exchange the paper cassette to be used, and supply sheets of paper from another paper cassette instructed by controller 8.

In the first embodiment structured like this, on the basis of detection results of existence of sheets of paper in the paper cassettes of main body 1, the indication of the symbol of paper size display 12a of image forming apparatus graphic 12 of touch panel 10 is changed in real time. Therefore, the user, without touching paper size display 12a, only by looking at image forming apparatus graphic 12 of touch panel 10, can recognize the empty paper cassette quickly and easily. Therefore, without performing a useless operation, he can immediately replenish sheets of paper, thus the operability can be improved.

Next, the aforementioned operation in the first embodiment will be explained by referring to the flow chart shown in FIG. 5.

When the power source of main body 1 is turned on (ST1), firstly in the initial state, existence of sheets of paper in paper cassettes 3, 4, and 5 is detected by paper detector 9 (ST2). As a result of detection of existence of sheets of paper in the initial state, when it is decided that sheets of paper are stored in all cassettes 3, 4, and 5 (YES at ST2), an existence of paper data signal is transmitted to touch panel 10 from controller 8 (ST3), and the effect of existence of paper is displayed for paper cassette graphics 16, 17, and 18 of touch panel 10 (ST4), and a copy operation by main body 1 is executed (ST5). As a result of detection of existence of sheets of paper in the initial state, when it is detected that sheets of paper are not stored in any of cassettes 3, 4, and 5 (NO at ST2), a non-existence of paper data signal is transmitted to touch panel 10 from controller 8 (ST6) and concerned paper cassette 16, 17, or 18 displays the effect of non-existence of paper (ST7). Namely, at ST7, as described previously, paper cassette 16, 17, or 18 applicable to non-existence of paper blinks or the density of the symbol is made lower or is turned off.

By the user confirming the indication of “non-existence of paper” on touch panel 10, sheets of paper of a predetermined size or a predetermined material are stored in the paper cassette of non-existence of paper (ST8).

During continuation of the copy operation at ST5, existence of sheets of paper in paper cassettes 3, 4, and 5 is detected by paper detector 9 (ST9). As a result of detection of existence of sheets of paper, when “non-existence of paper” is detected (YES at ST9), a non-existence of paper data signal is transmitted to touch panel 10 from controller 8 (ST10) and paper cassette graphic 16, 17, or 18 displays the effect of non-existence of paper (ST11). Namely, at ST11, as described previously, paper cassette 16, 17, or 18 applicable to non-existence of paper blinks or the density of the symbol is made lower or is turned off.

By the user confirming the indication of “non-existence of paper” on touch panel 10, sheets of paper of a predetermined size or a predetermined material are stored in the paper cassette of non-existence of paper (ST12). When sheets of paper are stored in the paper cassette of non-existence of paper (ST12), an existence of paper data signal is transmitted to touch panel 10 from controller 8 (ST13), and paper cassette graphics 16, 17, and 18 of touch panel 10 display the effect of existence of paper (ST14), and as shown at ST15, paper cassette graphics 16, 17, and 18 of touch panel 10 continue the indication of the effect of existence of paper. Namely, as a result of detection of non-existence of paper by paper detector 9 at ST9, when “existence of paper” is detected (NO at ST9), paper cassette graphics 16, 17, and 18 of touch panel 10 continue the indication of the effect of existence of paper (ST15). Furthermore, the copy operation is continued (ST16) and copy of a desired number is finished (ST17).

### Second Embodiment

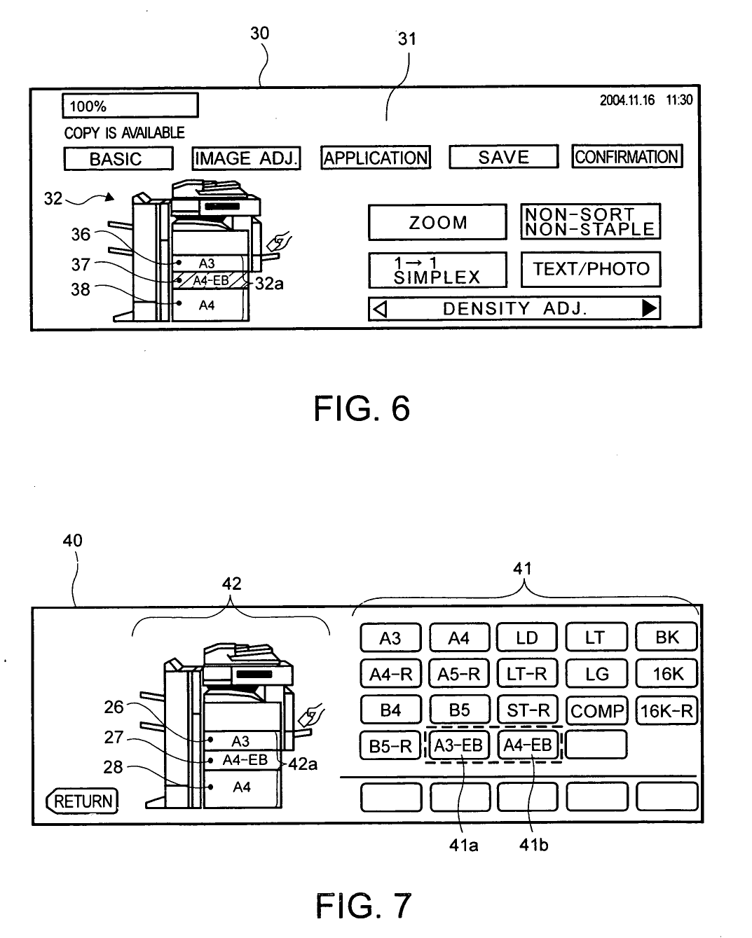

Next, the second embodiment of the present invention will be explained by referring to FIGS. 6 and 7. FIG. 6 is a plan view showing touch panel 30 on the operation panel installed in main body 1 of the image forming apparatus of the present invention. Main body 1 of this embodiment is an apparatus corresponding to forming of an image on a reused sheet of paper which is removed printed color losing toner and is used repeatedly. In the paper cassettes of main body 1, reused sheets of paper can be stored. Color losing toner, to make it possible to repeatedly reuse sheets of paper for saving of resources, after printing, can be peeled off mechanically or chemically. Or, color losing toner is exclusive toner capable of removing the printed part by reacting on heat, light, or chemicals.

However, when forming an image by reusing a sheet of paper which is printed using color losing toner and then loses the color of the printed part, compared with a case that an image is formed on a new sheet of paper, the charging characteristic, developing characteristic, transferring characteristic, or fixing characteristic of main body 1 may be required to be adjusted. Therefore, in main body 1 of this embodiment, for such forming of an image on a reused sheet of paper, the image forming characteristic can be adjusted.

In this embodiment, reused sheets of paper can be stored in the paper cassettes of main body 1, so that the indication of image forming apparatus graphic 32 on waiting screen 31 of touch panel 30 is set so as to discriminate and display reused sheets of paper and new sheets of paper. In the areas of paper cassette graphics 36 to 38 at the upper stage, medium stage, and lower stage of paper size display 32a of image forming apparatus graphic 32, the symbol indicating reused sheets of paper can be displayed. For example, when reused sheets of paper of size A4 are stored in cassette 4 at the medium stage of main body 1, in the area of paper cassette graphic 37 at the medium stage of touch panel 30, a symbol of A4-EB indicating reused sheets of paper of size A4 is displayed.

The symbol displayed on paper size display 32a, similarly to the first embodiment aforementioned, is set or changed by a user. To set a symbol of reuse, in paper size selecting portion 41 of paper size selection screen 40 of each cassette shown in FIG. 7, A3-EB icon 41a and A4-EB icon 41b for selecting reused sheets of paper are installed.

Further, when paper detector 9 detects that an optional paper cassette of main body 1 is empty, similarly to the first embodiment, it changes the indication of the stage equivalent to the empty paper cassette of paper size display 32a of image forming apparatus graphic 32 of touch panel 30. Paper detector 9 switches the indication of the stage equivalent to the empty paper cassette from the lighting indication of clear density to blinking and switches the density to low or off, thereby gives the user a warning that the paper cassette is empty. When the user replenishes sheets of paper into the paper cassette warned of empty and the sheets of paper are detected by paper detector 9, the warning indication of paper size display 32a is cancelled and is returned to the lighting indication of clear density.

Further, even when an optional paper cassette becomes empty and any other paper cassette is a cassette of the same paper size, main body 1 of this embodiment, since a case of new sheets of paper and a case of reused sheets of paper having the same paper size may occur, not to exchange the paper cassette by the auto cassette change operation, is set to the mode of executing no auto cassette change operation.

In the second embodiment structured like this, similarly to the first embodiment, the user, only by looking at image forming apparatus graphic 32 of touch panel 30, can recognize quickly and easily which paper cassette is empty and without performing a useless touch operation, can replenish sheets of paper, thus the operability can be improved. Further, the mode of executing no auto cassette change operation is set, so that in the main body for using appropriately new sheets of paper and reused sheets of paper, thereby adjusting the image forming characteristic, erroneous printing on new sheets of paper and reused sheets of paper can be prevented.

Further, the present invention is not limited to the embodiments aforementioned and can be modified within a range which is not deviated from the object of the present invention. For example, on the touch panel, if the kind and existence of sheets of paper of each paper cassette can be visually recognized immediately, the contents of the cassette selection screen are not limited. Further, the function of the main body of the image forming apparatus and the number of paper cassettes are exactly optional and an image forming apparatus having various functions such as a monochromatic image forming apparatus, a color image forming apparatus, or a multi function peripheral is available.

According to the present invention, by looking at the display screen of the touch panel, a user can recognize quickly and easily whether sheets of paper of a desired size are stored in the concerned paper cassette. Therefore, at time of setting image forming conditions from the touch panel, although the paper cassette is empty, he performs no paper cassette selection operation, thus the useless operation for selection of the paper cassette can be prevented, and the operability can be improved.

What is claimed is:

1. An image forming apparatus comprising:
a main body;
a plurality of paper cassettes provided in the main body to respectively store sheets of paper;
a touch panel equipped with a selection screen to indicate graphics to express the plurality of paper cassettes and by touching one of the indicated graphics by a user, selecting one paper cassette to be used; and
a display controller, among graphics to indicate the plurality of paper cassettes, to control so as to change an indication condition between a case that sheets of paper are stored in the paper cassettes and a case that no sheets of paper are stored therein.

2. The image forming apparatus-according to claim 1, wherein the display controller, as compared with density of the indication when the sheets of paper are stored in the paper cassettes, controls so as to make density of the indication when the sheets of paper are not stored in the paper cassettes lower.

3. The image forming apparatus according to claim 1, wherein the display controller controls to turn off the indication of the graphic corresponding to the paper cassette where the sheets of paper are not stored when the sheets of paper are not stored in any of the paper cassettes.

4. The image forming apparatus according to claim 1, wherein the display controller controls so as to blink the indication of the graphic corresponding to the paper cassette where the sheets of paper are not stored when the sheets of paper are not stored in any of the paper cassettes.

5. A touch panel display method of an image forming apparatus to display a cassette selection screen to select any of a plurality of paper cassettes provided in a main body of the apparatus on a touch panel for which a user can perform a touch operation, comprising:
detecting whether sheets of paper are stored in the plurality of paper cassettes or not; and
changing an indication of the cassette selection screen according to detecting results of whether the sheets of paper are stored or not.

6. The touch panel display method according to claim 5, wherein the indication of the cassette selection screen is changed, as compared with density of the indication when it is detected that the sheets of paper are stored in the paper cassettes, so as to make density of the indication when it is detected that the sheets of paper are not stored in the paper cassettes lower.

7. The touch panel display method according to claim 5, wherein the indication of the cassette selection screen is changed, when it is detected that the sheets of paper are not stored in any of the paper cassettes, to turn off the indication of the graphic corresponding to the paper cassette where the sheets of paper are not stored.

8. The touch panel display method according to claim 5, wherein the indication of the cassette selection screen is changed, when it is detected that the sheets of paper are not stored in any of the paper cassettes, to blink the indication of the graphic corresponding to the paper cassette where the sheets of paper are not stored.
